(19) United States
(12) Patent Application Publication
(10) Pub. No.: US 2010/0093311 A1
(43) Pub. Date: Apr. 15, 2010

(54) MOBILE INFORMATION PROCESSING APPARATUS, OPERATIONAL ITEM EXECUTION CONTROL PROGRAM AND OPERATIONAL ITEM EXECUTION CONTROL METHOD

(76) Inventor: Katsuhisa Ide, Tokyo (JP)

Correspondence Address: Mr. Jackson Chen, 6535 N. STATE HWY 161, IRVING, TX, 75039, US

(21) Appl. No.: 12/529,384

(22) PCT Filed: Jan. 25, 2008
(86) PCT No.: PCT/JP2008/051067

§ 371 Date: Sep. 1, 2009

(30) Foreign Application Priority Data
Mar. 7, 2007 (JP) 2007-057687

(51) Int. Cl. G05B 19/04; H04M 1/66

(52) U.S. Cl. 455/411; 340/5.8

(57) ABSTRACT

A mobile-information-processing apparatus includes: capacitance sensors 108 each detecting capacitance at multiple points in a designated area; pattern-registering means 129 registering multiple mapped patterns of capacitance at multiple points in the designated area, obtained from the detection result of capacitance sensors 108; pattern/operational-item registering means 131 registering the result of selection when two or more patterns are selected in a designated order from the registered multiple mutually different patterns in combination with a particular operational item for the apparatus; pattern-evolution-determining means 124 determining the temporal evolution of the pattern from capacitance sensors 108; pattern-time-axis-consistency/inconsistency-determining means 124 determining whether the evolution of the pattern is consistent on the time axis with the order of the patterns in pattern/operational-item-registering means 131; and operational-item-executing means 132 which, when consistency was determined, executes the operational item corresponding to the patterns determined to be consistent, among the operational items in pattern/operational-item-registering means 131.

### TECHNICAL FIELD

The present invention relates to a mobile information processing apparatus such as a mobile phone etc., an operational item execution control program and an operational item execution control method, and in particular relates to a mobile information processing apparatus, an operational item execution control program and an operational item execution control method, suitable for providing security.

### BACKGROUND ART

Mobile information processing apparatuses such as mobile phones, PHSs (Personal Handy-phone Systems), PDAs (Personal Digital Assistants) and the like have become advanced. For example, there are many mobile information processing apparatuses that can handle personal information such as email, address book and/or record of incoming calls. There are also mobile information processing apparatuses having a function of storing electronic money. Accordingly, if such a mobile information processing apparatus is illegally used by others, there is a fear of important personal information leaking and also there is a risk of suffering a financial loss equivalent to losing a purse.

To deal with this, various kinds of security have been contrived for mobile information processing apparatuses. For example, there has been considered a mobile information processing apparatus which activates designated functions, which need to keep security, only when a series of numerals corresponding to a personal code number that was previously set is input.

However, in authentication management based on personal code numbers, it is possible to go through the security in a relatively simple manner if a personal code number that can be analogized is designated. Alternatively, if the user designates a complex personal code number, there are cases where the user himself cannot remember the personal code number.

To deal with this, there has been a proposal for using the user's fingerprint (e.g., see patent document 1). In this proposal, a 2 cm×2 cm capacitance sensor array is used as a fingerprint sensor so as to perform pattern detection of a fingerprint. Then, the pattern of the detected fingerprint is compared to the pattern of the fingerprint already registered. When the two patterns coincide, the main power is turned on so as to make the mobile phone function executable.

Patent document 1: Japanese Patent Application Laid-open 2003-298689 ([0016], [0043], FIG. 2).

### DISCLOSURE OF INVENTION

### Problems to be Solved by the Invention

However, provision of a fingerprint sensor for a mobile phone means that the user's fingerprint constantly remains on the sensor surface. Accordingly, this is the serious problem in view of protecting the pattern of the registered fingerprint and from a privacy viewpoint.

Further, when pattern comparison between fingerprints is performed, the finger needs to be kept free from soil and moisture in both the cases when it is registered and when compared. Further, it is impossible to perform exact pattern detection unless the moisture of the finger is wiped off using a cloth that will not leave lint. From these reasons, if fingerprint authentication is attempted to be done with high accuracy, failures in the registration and authentication process will increase. If authentication accuracy is lowered to avoid this, there occurs the problem of being unable to perform satisfactory authentication.

Further, it is necessary for the user to operate the keys in the control portion separately for operational items.

The object of the present invention is to provide a mobile information processing apparatus, an operational item execution control program and an operational item execution control method that can solve the above problems.

### Means for Solving the Problems

A mobile information processing apparatus of the present invention includes: an arbitrary number of capacitance sensors detecting capacitance at multiple points in a designated area; a pattern registering means registering a plurality of mapped patterns of capacitance at said multiple points in said designated area, obtained from the detection result of said arbitrary number of capacitance sensors; a pattern/operational item registering means in which the result of selection when two or more patterns are selected in a designated order from the multiple mutually different patterns registered in said pattern registering means is registered in combination with a particular operational item for the apparatus; a pattern evolution determining means determining the temporal evolution of said pattern from said arbitrary number of capacitance sensors; a pattern-time axis consistency/inconsistency determining means determining whether the evolution of said pattern determined by said pattern evolution determining means is consistent on the time axis with the order of the multiple patterns registered in said pattern/operational item registering means; and an operational item executing means which, when consistency is determined by said pattern-time axis consistency/inconsistency determining means, executes the operational item corresponding to said multiple patterns that are determined to be consistent, among the operational items registered in said pattern/operational item registering means.

An operational item execution control program of the present invention makes a computer that is a mobile information processing apparatus having an arbitrary number of capacitance sensors which detects capacitance at multiple points in a designated area and which is arranged in a designated portion on a casing surface, execute: a pattern registering process of registering a plurality of mapped patterns of capacitance at said multiple points in said designated area, obtained from the detection result of said arbitrary number of capacitance sensors; a pattern/operational item registering process in which the result of selection when two or more patterns are selected in a designated order from the multiple mutually different patterns registered in said pattern registering process, is registered in combination with a particular operational item for the apparatus, into a pattern/operational item registering means; a pattern evolution determining process of determining the temporal evolution of said pattern from said arbitrary number of capacitance sensors; a pattern-time axis consistency/inconsistency determining process of determining whether the evolution of said pattern determined by said pattern evolution determining process is consistent on the time axis with the order of the multiple patterns registered by said pattern/operational item registering means; and an operational item executing process which, when consistency was determined in said pattern-time axis consistency/inconsistency determining process, executes the operational item corresponding to said multiple patterns determined to be consistent, among the operational items registered in said pattern/operational item registering means.

An operational item execution control method of the present invention is an operational item execution control method effected by a mobile information processing apparatus having an arbitrary number of capacitance sensors detecting capacitance at multiple points in a designated area, arranged in a designated portion on a casing surface, and includes: registering a plurality of mapped patterns of capacitance at said multiple points in said designated area, obtained from the detection result of said arbitrary number of capacitance sensors; registering the result of selection when two or more patterns are selected in a designated order from said registered multiple mutually different patterns, in combination with a particular operational item for the apparatus, into a pattern/operational item registering means; determining the temporal evolution of said pattern from said arbitrary number of capacitance sensors; determining whether the evolution of said pattern is consistent on the time axis with the order of the multiple patterns registered in said pattern/operational item registering means; and when said consistency is determined, executing the operational item corresponding to said multiple patterns determined to be consistent, among the operational items registered in said pattern/operational item registering means.

### Effect of the Invention

According to the present invention, since the user determines each pattern by placing the hand and/or a conductor freely on the capacitance sensor, the pattern may have high flexibility. Besides, when the pattern is determined using the hand, the shape of the hand and how the fingers of the hand are placed are different from individual to individual. Accordingly, if the rock, paper scissors patterns are formed by hand, the patterns will be different from person to person. For this reason, it is possible to perform authentication with a higher reliability using fewer patterns compared to authentication based on combination of figures.

Further, since personal biometric information such as fingerprint, pupils is not used to execute authentication or individual operational items, there is no fear of the user's privacy leaking or body tissues such as pupils etc. receiving adverse influence. Further, it is also possible to realize intuitive operation without using any key.

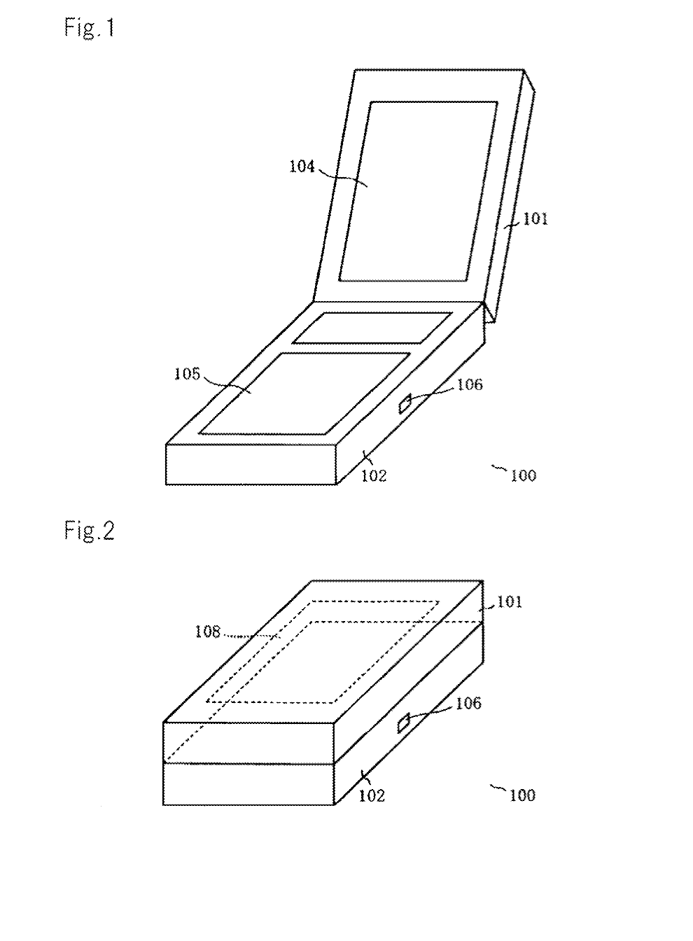

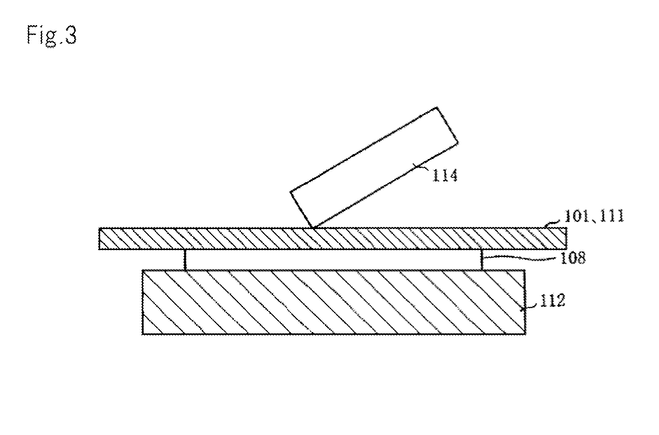

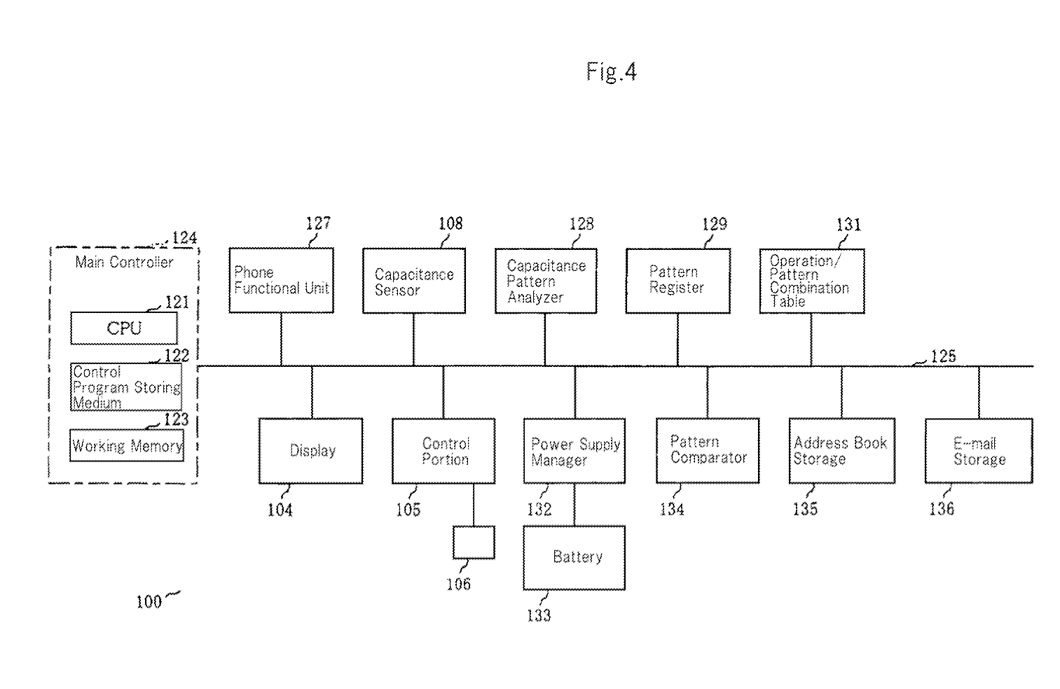

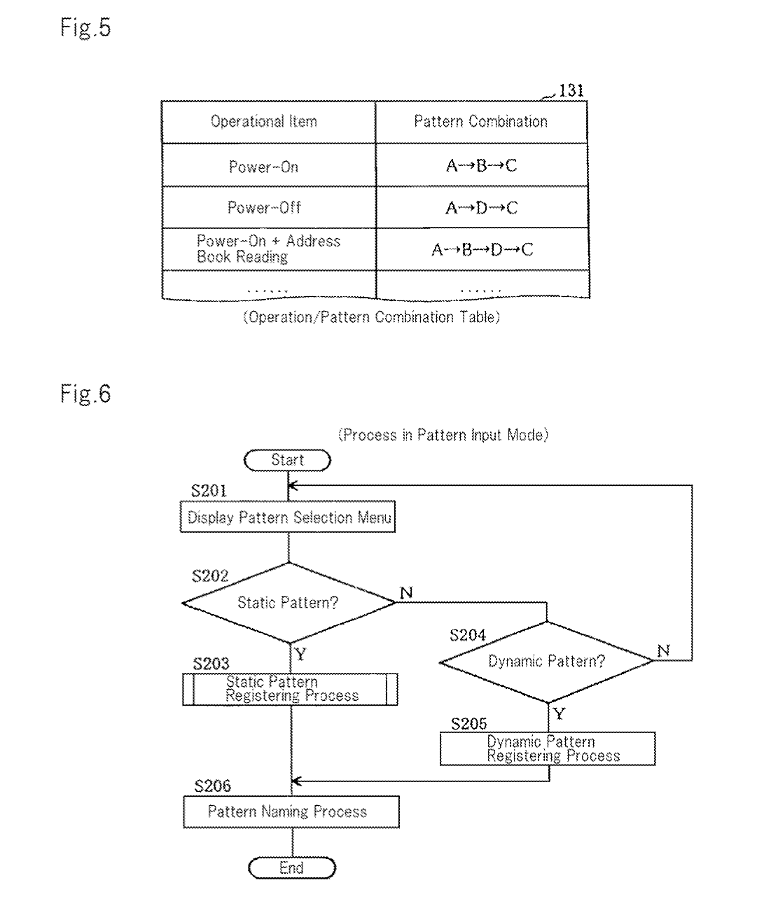

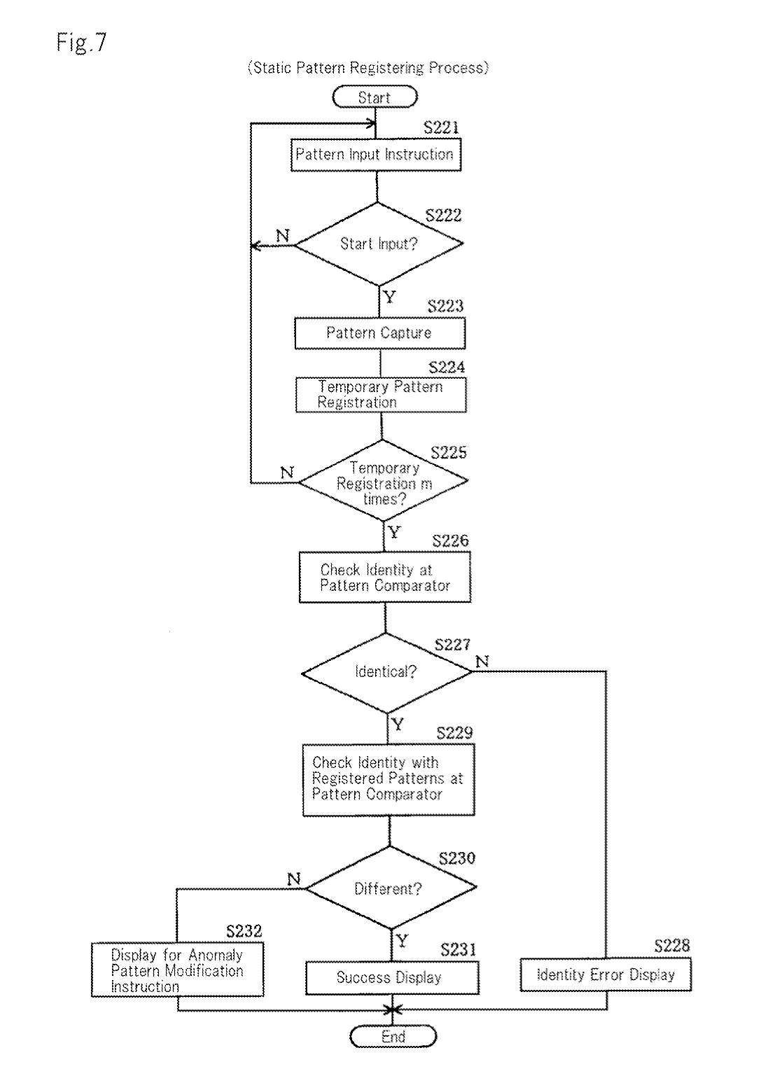

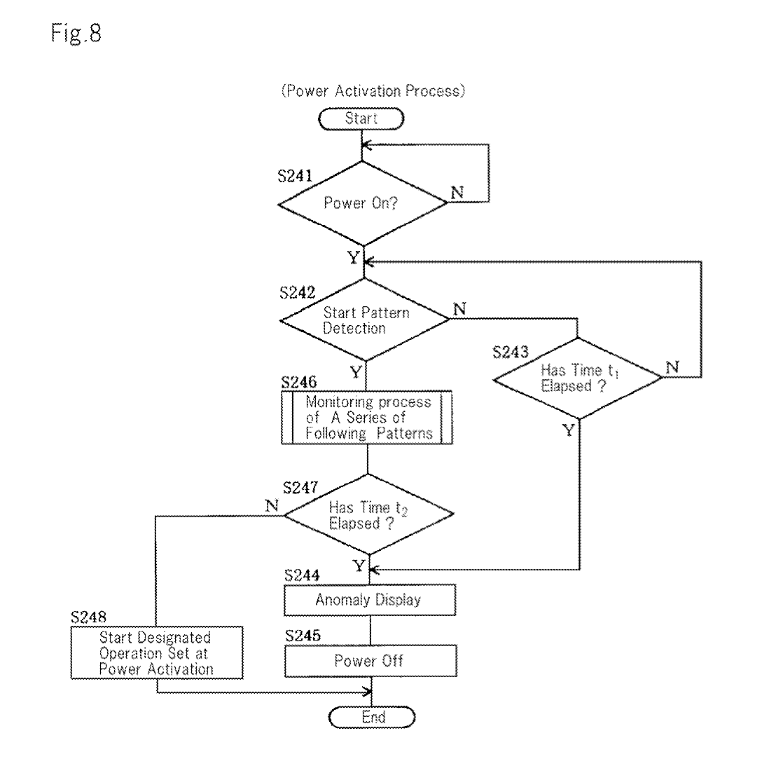

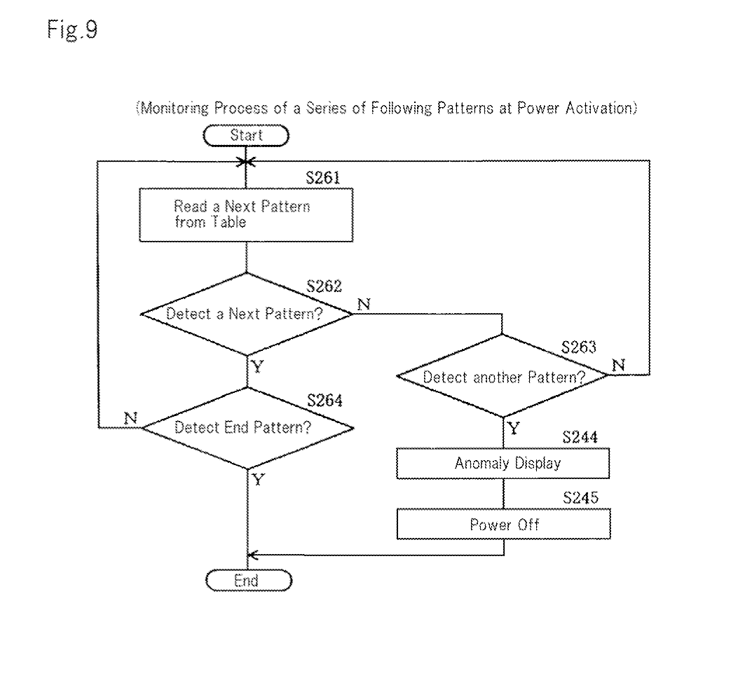

### BRIEF DESCRIPTION OF DRAWINGS

[FIG. 1] is a perspective view showing a folding type mobile phone in one exemplary embodiment of the present invention in its unfolded state for operation.

[FIG. 2] is a perspective view showing a mobile phone of the present exemplary embodiment in its folded state.

[FIG. 3] is a sectional view showing essential parts of a first casing of a mobile phone of the present exemplary embodiment.

[FIG. 4] is a block diagram showing the scheme of a circuit configuration of a mobile phone of the present exemplary embodiment.

[FIG. 5] is an illustrative view showing a registration example in an operation/pattern combination table of the present exemplary embodiment.

[FIG. 6] is a flow chart showing the flow of pattern registering processes of individual patterns in the present exemplary embodiment.

[FIG. 7] is a flow chart specifically showing the static pattern registering process in FIG. 6.

[FIG. 8] is a flow chart showing the way of an authentication process in a power activation operation, as one example of the ways of control for operational items in the present exemplary embodiment.

[FIG. 9] is a flow chart specifically showing a monitoring process of a series of patterns that is performed at the time of a power activation operation in the present exemplary embodiment.

### DESCRIPTION OF REFERENCE NUMERALS

100 Mobile phone
106 Switch
108 Capacitance sensor
121 CPU
122 Control program storing medium
124 Main controller
128 Capacitance pattern analyzer
129 Pattern register
131 Operation/pattern combination table
132 Power supply manager
134 Pattern comparator

### BEST MODE FOR CARRYING OUT THE INVENTION

Next, the exemplary embodiment of the present invention will be described in detail.

### Exemplary Embodiment 1

FIG. 1 is a view showing a folding type mobile phone in one exemplary embodiment of the present invention in its unfolded state for operation. Mobile phone 100 includes two casings, or first casing 101 and second casing 102. First casing 101 and second casing 102 are arranged in an openable and closable manner by means of an unillustrated hinge mechanism. Provided on the side of first casing 101 that faces second casing 102 when it is folded is display 104 made of liquid crystal or organic EL (organic electroluminescence). Arranged on the side in second casing 102 opposing display 104 is control portion 105 constituted of a plurality of keys. Further, switch 106 constituting control portion 105 is also arranged on the side of second casing 102.

FIG. 2 is a view showing mobile phone 100 in its folded state. Capacitance sensor 108 in a relatively large sheet form is arranged in first casing 101, adjacently to the surface on the opposite side of display 104 shown in FIG. 1.

FIG. 3 is a view showing the sectional structure of essential parts of first casing 101. Sheet-like capacitance sensor 108 is provided between thin plate-like mold resin 111 that forms the surface of first casing 101 and main body mechanical part 112.

Though not illustrated, capacitance sensor 108 is formed of a large number of capacitance detecting elements arranged matrix-wise. Capacitance sensor 108 outputs variations in capacitance of these capacitance detecting elements as a 2-dimensional pattern. Accordingly, when, for example, the user puts a finger or hand 114 in contact with, or in close vicinity to, mold resin 111, the information that represents the 2-dimensional capacitance in accordance with this will be output from capacitance sensor 108. An opening is formed in first casing 101 so that capacitance sensor 108 may be exposed through the opening. In the exemplary embodiment, from design and durability viewpoints, the surface of capacitance sensor 108 is covered with mold resin 111.

Here, capacitance sensor 108 can be generally called an arbitrary number of capacitance sensors. Capacitance sensor 108 detects capacitance at plural points in a designated area (the detecting area of capacitance sensor 108).

FIG. 4 is a diagram showing the scheme of a circuit configuration of the mobile phone of the present exemplary embodiment. Mobile phone 100 includes CPU (Central Processing Unit) 121, control program storing medium 122 such as ROM (Read Only Memory) etc. in which control programs executed by CPU 121 are stored, and main controller 124 having working memory 123 such as RAM (Random Access Memory) etc. Main controller 124 is connected via connecting means 125 such as a data bus etc. to each part in the apparatus described hereinbelow.

Here, mobile phone 100 can be generally called a mobile information processing apparatus. Also, main controller 124 can be generally called a pattern evolution determining means and a pattern-time axis consistency/inconsistency determining means. Further, control program storing medium 122 can be generally called a computer-readable recording medium.

Phone functional unit 127 is the general term representing the circuit portions for performing the telephone function as the inherent function of mobile phone 100. Though not illustrated, phone functional unit 127 is composed of diverse parts such as a communication controller and voice input/output portion. As to display 104, control portion 105 and capacitance sensor 108, description has already been given.

Capacitance pattern analyzer 128 reads the output from capacitance sensor 108 at regular intervals to analyze the capacitance pattern for every frame that corresponds to the plane constituting the sensor. Pattern register 129 is adapted to register a plurality of patterns or pattern groups which are temporal variation of patterns. Operation/pattern combination table 131 is a table in which combinations of designated operations including activation of power supply and patterns are registered. Power supply manager 132 is connected to battery 133 to operate mobile phone 100 and to control power supply to each part. Pattern comparator 134 is adapted to compare the capacitance pattern analyzed by capacitance pattern analyzer 128 and the pattern registered in pattern register 129.

Here, pattern register 129 can be generally called a pattern registering means. Operation/pattern combination table 131 can be generally called a pattern/operational item registering means. Power supply manager 132 can be generally called an operational item executing means.

Main controller 124 registers the result of selection when two or more patterns were selected in a designated order from a plurality of mutually different patterns registered in pattern register 129, in combination with a particular operational item for the apparatus, into operation/pattern combination table 131.

Also, main controller 124 determines temporal evolution of the pattern from capacitance sensor 108.

Further, main controller 124 determines whether the evolution of the pattern on the time axis coincides with the order of multiple patterns registered in operation/pattern combination table 131.

Address book storage 135 is a memory area for storing data relating to an address book. E-mail storage 136 is a memory area for storing data relating to e-mails, transmitted, received or in preparation. At least part of the components, other than main controller 124, can be realized software-wise by executing the control programs stored in control program storing medium 122.

FIG. 5 is a view showing a registration example in operation/pattern combination table 131 of the present exemplary embodiment. Registered in operation/pattern combination table 131 are the relationships between the operational items for operating mobile phone 100 shown in FIG. 4 using capacitance sensor 108 and the combinations of necessary patterns for these operations.

For example, in order for power supply manager 132 shown in FIG. 4 to perform a “power-on” process for turning on the power supply to level that is higher than the minimum required for control, a pattern combination “A->B->C” is needed. Here, “->” indicates a lapse of time. That is, this pattern combination is given to indicate that the power supply is turned on when pattern “A”, pattern “B”, then pattern “C” appear sequentially.

For a “power-off” process for forcibly cutting off the power supply, a pattern combination “A->D->C” is designated. Accordingly, power supply manager 132 will cut off the power supply when pattern “A”, pattern “D” and then pattern “C” appear sequentially.

The operational item for a “power-on+address book reading” process is an operational item, not only for turning on the power supply of mobile phone 100 but also for permitting a reading operation of the address book as necessary. Accordingly, when the power supply to mobile phone 100 is turned on in order to perform an operation entailing input/output of data associated with address book storage 135 shown in FIG. 4, it is necessary to realize a combination of patterns, in which pattern “A”, then pattern “B”, subsequently pattern “D” and finally pattern “C” appear. When a phone call is made without using the address book or when there is no need of checking or editing the address book, it is sufficient that the power supply to mobile phone 100 is turned on by the pattern combination of “A->B->C”.

By the way, in looking at the various kinds of pattern combinations registered in operation/pattern combination table 131, all the combinations start with pattern “A” and end with pattern “C”. The former is called “start pattern”, and when this pattern appears, pattern comparator 134 and main controller 124 shown in FIG. 4 start a time-sequential pattern comparing process. The latter is called “end pattern”, and when this pattern appears after the “start pattern” has appeared, registered patterns among the patterns that have appeared up to then will be checked in a time-sequential manner.

The description heretofore corresponds to the case where each pattern such as pattern “A” etc. is a static pattern. When the pattern is a dynamic pattern, it is not necessary to define a particular “start pattern”. Since a dynamic pattern itself represents a time-sequential change of multiple static patterns, the dynamic pattern by itself can provide discrimination that is distinguishable from usual events.

Further, the combinations of patterns in operation/pattern combination table 131 do not include any cases where the same patterns such as “D->D” appear two or more times in a row. This is because of the rule that every time a pattern appears, the pattern is determined as a single pattern no matter whether detection time of the pattern is short or long, on the premise that it is difficult for the user side to recognize that the detection of the pattern should be divided into plurals after how long the pattern has been detected. Of course, the time of an identical pattern appearing continuously may be measured so as to determine that the same patterns such as “D->D” have appeared two times in a row if the measured time is longer than a particular threshold and to determine that a mere single pattern has appeared if the time is equal to or shorter than the threshold.

FIG. 6 is a chart showing the flow of registering processes of individual patterns. Description will be given with FIG. 4. At Step S201, when the user sets mobile phone 100 into pattern input mode by operating control portion 105, a selection menu for selecting either the static pattern or the dynamic pattern is displayed. Here, the static pattern is a pattern of one frame in its static state and the dynamic pattern is a pattern of multiple frames changing within a fixed time.

When the user selects the static pattern at Step S202, a registering process for a static pattern is executed. When the dynamic pattern is selected at Step S204, a registering process for a dynamic pattern is executed. After completion of either of the registering processes, a process for assigning a pattern name to the static pattern or dynamic pattern is performed at Step S206. “A” and “B” in pattern “A” and pattern “B” described in operation/pattern combination table 131 are the pattern names.

FIG. 7 is a chart specifically showing the static pattern registering process in FIG. 6. Description will be given with FIG. 4.

When a static pattern registering process is started at Step S203 in FIG. 6, the input instruction of a static pattern is displayed on display 104 at Step S221. The instruction may be given by voice. When viewing this display on display 104, the user folds up mobile phone 100 as shown in FIG. 2. Then, the user grips mobile phone 100 by using only the extended forefinger, for example. At this time, the forefinger and its surrounding space are present on capacitance sensor 108. In this condition, the user pushes switch 106 by using the hand griping mobile phone 100 or the other hand.

Then, input of the pattern from capacitance sensor 108 is started at Step S222. At Step S223, capacitance pattern analyzer 128 captures the pattern and capacitance pattern 128 temporarily registers a single frame pattern after analysis into pattern register 129 at Step S224. Here, capacitance pattern analyzer 128 binarizes input capacitance at each point or changes input capacitance at each point into multi-values, removes fine noise and corrects the contour as necessary.

After temporal registration of the pattern was done, main controller 124 checks whether this temporal registration has been done m times in total (here m is an arbitrary integer equal to 2 or greater). If it is less than m times, the control goes back to Step S221 and the next pattern input instruction is given. When this instruction is adapted to be given by voice, the user does not need to unfold mobile phone 100 and look at display 104. In this regard, if the type of a mobile phone having another display, which is not illustrated, provided on the detection side of capacitance sensor 108, when phone 100 is folded up, is used, it is possible to display the processing status and instruction on this display.

At Step S225, m times of static pattern temporary registration have been done, pattern comparator 134 checks whether these m patterns are determined to be identical at Step S226. This is done because identify of these capacitance patterns cannot be maintained even if, for example, the user repeats input of static patterns, with the intention of registering pattern “A”, in a state that the user, in some cases, performs input with the forefinger alone while the user performs input with two fingers, the forefinger and middle finger, in other cases. This is why the identity of the static patterns is checked.

At Step S227, if any one of the m patterns is not identical with the others, an error sound is output while an error indication such as “This is a pattern whose identity cannot be maintained. Please select another pattern or perform another input operation.” is given on the display. The pattern that is not successfully accepted even if input is repeated many times cannot be stably input in the same patterns, so that the user needs to try to input a different pattern.

On the other hand, when identity of the m patterns has been established, the average pattern is selected from these, and at Step S229 pattern comparator 134 checks whether the pattern is identical with the other patterns that have already been registered in pattern register 129. This is because problems occur if pattern “A” is identical with pattern “B”, for example. At Step S230, if there exists no pattern identical to the selected pattern in pattern register 129, at Step S231 a message or sound indicating success is output while a success display such as “this pattern can be registered” is given. At Step S231, the same success display is given if there is no registered pattern to be compared to.

On the other hand, if at Step S230 a pattern, which is identical with the selected pattern, has already existed in pattern register 129, an error sound is output while an error display such as “The same pattern has been already registered. Please input a different pattern.” is given at Step S232.

Here, the dynamic pattern registering process performed at Step S205 differs from the static pattern registering process in that a dynamic pattern consisting of multiple frames within a designated period is registered, but other than this, the process is basically the same as the static pattern registering process. So, detailed description of the dynamic pattern registering process performed at Step S205 is omitted.

As having registered several patterns such as pattern “A” to pattern “D” in the above way, the user will create operation/pattern combination table 131 shown in FIG. 5, making these correspondent to individual operational items.

For example, the user operates control portion 105 so as to select two or more patterns from a plurality of mutually different patterns in pattern register 129, in a designated order. Main controller 124 registers the result of selection in combination with a particular operational item for the apparatus, into operation/pattern combination table 131.

FIG. 8 shows the flow of the identification process in the power activation operation as one example of ways to control operational items. Description will be given with FIGS. 4 and 5. It is assumed that at Step S241 the user turned on the power supply to mobile phone 100 by, for example, keeping switch 106 shown in FIG. 1, depressed down. At Steps S242 and S243, main controller 124 checks whether the start pattern will be detected within time t1 from then on. Time t1 is set to be 15 seconds or 30 seconds, for example. The user may adjust this time arbitrarily.

If time t1 has elapsed at Step S243 without detecting start pattern “A” registered in operation/pattern combination table 131 at Step S242, main controller 124 will give an anomaly display for a fixed time on display 104 at Step S244, and will turn off the power at Step S245. The anomaly display at Step S245 may be omitted for power saving.

On the other hand, if start pattern “A” is detected before time t1 lapses at Step S242, a monitoring process of a following series of patterns registered in operation/pattern combination table 131 will be executed at Step S246. Then, if this monitoring process has been effected without failure, whether time t2 has elapsed by that time is checked at Step S247. If the lapse of time is not too long, the operation of mobile phone 100 will be started within the range of security set by power activation at Step S248.

In contrast, when designated time t2 has already lapsed at Step S247, the control goes to Step S244, where an anomaly display is given and the power is turned off at Step S245. Here, the process at Step S247 may be omitted, and control may go directly to Step S248 when the process at Step S246 has been successfully done.

Here, Steps S242, S243, S246 and S247 are executed by main controller 124 and pattern comparator 134. Step S244 is executed by main controller 124 and display 104. Step S245 is executed at power supply manager 132. Step S248 is executed by controller 124 and power supply manager 132.

FIG. 9 is a chart specifically showing a monitoring process of a series of patterns that follow at the time of power activation as the process at Step S246. Description will be given with FIGS. 4 and 5. When start pattern “A” is detected at Step S242, main controller 124 reads out patterns that have been registered in operation/pattern combination table 131 so as to follow start pattern “A” in association with the authentication process for power activation, at Step S261. As authentication processing associated with power activation, there are two operational items, “power activation” which is set at a low security level and “power activation+address book reading”, which is set at a high security level. In either case, the following pattern is pattern “B”. Accordingly, pattern “B” is read out. However, if there are two kinds of operational items in the above way but the following patterns are different from each other, the two patterns are read out.

Next, main controller 124 checks whether the read out pattern or pattern “B” is detected by capacitance sensor 108 at Step S262, or whether another pattern that has been registered in operation/pattern combination table 131 is detected before detection of the above pattern, at Step S263. In this example, it is assumed, for example, that pattern “D” or unillustrated pattern “E” instead of pattern “B” is detected at Step S263 after start pattern “A”. Then, control does not go to Step S247 in FIG. 8 in this case but goes to Step S244 and performs anomaly display and cuts off the power supply at Step S245. That is, the authentication results in failure so that the power to mobile phone 100 is cut off.

In contrast, when pattern “B” is detected after start pattern “A” at Step S262, a check is made to determine whether the currently detected pattern is end pattern “C” for power activation operation. In this case, the currently detected pattern is not end pattern “C”. Then, at Step S261, main controller 124 reads out the next patterns registered in operation/pattern combination table 131. The next pattern associated with power activation is either end pattern “C” (operational item for “power-on”) or pattern “D” (operational item for “power-on+address book reading”). Accordingly, in this case, end pattern “C” and pattern “D” are both read out.

In this condition, main controller 124 checks whether pattern “B” or “C” is detected by capacitance sensor 108 at Step S262, or whether another pattern that has been registered in operation/pattern combination table 131 is detected before detection of the above pattern, at Step S263. As the patterns other the above, if any one of patterns “A”, “D” and “E” is detected first at Step S263, the authentication results in failure so that control goes to Step S244 where anomaly display is given and the power supply is turned off at Step S245.

On the other hand, when pattern “C” is detected as the following pattern at Step S262, main controller 124 recognizes that this is the end pattern. Accordingly, control goes to Step S247 in FIG. 8, and if the condition with time t2 is satisfied, the operation of mobile phone 100 at a low security level is permitted.

In contrast, when pattern “D” is detected after pattern “B” at Step S262 in FIG. 9, the currently detected pattern is determined not to be end pattern “C” at Step S264.

Then, control goes once again to Step S261, end pattern “C” is read out as the following pattern from operation/pattern combination table 131. Then, in this case, a check is made to determine whether the pattern detected by capacitance sensor 108 is this end pattern “C” at Step S262, or whether the pattern detected by capacitance sensor 108 is any one of patterns “A”, “B”, “D” and “E”, other than end pattern “C” at Step S263.

As a result of this, if any one of patterns “A”, “B”, “D” and “E” is detected first at Step S263, the authentication results in failure so that an anomaly display is given and the power is cut off at Step S245.

On the other hand, when pattern “C” is detected as the following pattern at Step S262, it is determined that this is the end pattern at Step S264. Accordingly, control goes to Step S247 in FIG. 8, and if the condition with time t2 is satisfied, the operation of mobile phone 100 at a high security level is permitted.

Though, in the exemplary embodiment described above, description was made on the case where the operational items are realized when the power supply is activated, it is possible to realize other operational items in the same manner without linkage with the process of power activation.

In a mobile phone in which the power supply to main controller 124 is not off when power supply is cut off, the process can be started from detection of the start pattern by omitting the process at Step S241. In this case, the user may immediately start the action corresponding to start pattern “A” in the state in which mobile phone 100 is folded up, in order to enable the operation of the process at Step S246. Accordingly, no timeout process at Step S243 is needed in this case as well. Switch 106 also is not necessary.

Further, in this latter example, as for the other operational items that have been registered in advance in operation/pattern combination table 131, if the order of patterns detected by capacitance sensor 108 corresponds to any one of the pattern combinations in this prepared operation/pattern combination table 131, the operational item corresponding to it can also be realized.

Though it was assumed in the present exemplary embodiment that all the patterns inclusive of the start pattern are detected by capacitance sensor 108, a part of the detection may be used together with detection using an unillustrated acceleration sensor. For example, the shaking of mobile phone 100 by a user in a designated direction is adapted to be detected by the acceleration sensor, so that this detection result may be used as the start pattern before starting detection of each pattern by capacitance sensor 108.

Further, in the present exemplary embodiment, one sheet of capacitance sensor 108 having a relatively large size was used for detection of a static pattern or dynamic pattern. However, capacitance sensor 108 may use a plurality of capacitance sensors of a relatively small size arranged apart on the same flat area, so that the detected patterns by these may be used. It is also fully possible in this arrangement to distinguish various kinds of patterns such as a detection pattern when all of mobile phone 100 is converted by the palm, “the operation of drawing a line by the action of the forefinger alone”, “the operation of setting the forefinger” and the like.

Further, in the present exemplary embodiment, in a situation that a plurality of patterns from capacitance sensor 108 take place in the order of the multiple patterns registered in operation/pattern combination table 131, if any one of different patterns registered in pattern register 129 intervenes, main controller 124 determines it as being inconsistent and performs an error process. However, in a situation that a plurality of patterns from capacitance sensor 108 take place in the order of the multiple patterns registered in operation/pattern combination table 131, if any one of different patterns registered in pattern register 129 intervenes, main controller 124 may determine it as being consistent, neglecting the intervention of the different pattern without performing any error process. This configuration is effective for a novice user, who has created a different pattern in the course of operation and notices this and continues to add correct patterns, to lead the operation successful.

Further, though, in the present exemplary embodiment, an area sensor is used as the capacitance sensor, a one-dimensional capacitance sensor may be used to scan the designated area so as to realize two-dimensional pattern recognition. Moreover, though in the present exemplary embodiment, the “start pattern” and the “end pattern” are used, it is naturally understood that these may not be necessarily used.

Further, though, in the present exemplary embodiment, the address book is assumed to be the target for which security is to be provided, it is naturally understood that it is possible to impose restrictions by operational items on reading, editing and/or outputting transmitted and received e-mails, e-mails in preparation and/or various files etc., which generally need security.

Furthermore, in the present exemplary embodiment, even in a mobile phone made of capacitance sensor 108, main controller 124, capacitance pattern analyzer 128, operation/pattern combination table 131, pattern comparator 134 and power supply manager 132 can produce the same operational effect as above.

Still more, the object of the present exemplary embodiment is to provide a mobile information processing apparatus and an operational item execution control program in which there are no privacy concerns due to the use of biometric authentication without causing accuracy degradation of authentication.

Further, another object of the present exemplary embodiment is to provide a mobile information processing apparatus and an operational item execution control program which can execute various kinds of operations using a capacitance sensor.

In the present exemplary embodiment, one or plural capacitance sensors are used to detect capacitance at plural points in a designated area smaller than the size of a human hand. With this, the user creates a plurality of mapped patterns of capacitance by forming shapes such as covering this capacitance sensor with the palm, placing one finger at a fixed position on the sensor, or placing two or three fingers on the sensor, etc. These patterns are combined together on the time axis and recorded beforehand in association with an operational item. In using the apparatus, the pattern evolution determining portion is made to determine the temporal evolution of the pattern based on the capacitance sensor, and a check is made on the time axis to determine whether this corresponds to any of the multiple orders of patterns registered by the patter/operational item register. If consistency is determined, the corresponding operational item registered in pattern/operational item register will be executed. With this configuration, if the user places rock paper scissors hand game on the capacitance sensor, the previously registered operational item will be executed.

Here, an arbitrary number of capacitance sensors may be a plurality of capacitor sensors allotted in the same flat area or may be a single flat sensor that covers a single flat area. Further, an arbitrary number of capacitance sensors may be constructed of a scanning type one-dimensional capacitance sensor. In the pattern/operational item register, combinations of pattern orders may be registered in correspondence with respective proper plural operational items, or one combination of a pattern order may be registered.

Determination by the pattern-time axis consistency/inconsistency determining portion on whether a plurality of pattern orders are consistent on the time axis, may be given as being inconsistent when any of different patterns registered in the pattern register take place in the course in which patterns occur following the correct order, or may be given as being consistent even if any of the different patterns registered in the pattern register occur in the course on the time axis, by neglecting intervention of these different patterns.

In the present exemplary embodiment, the mobile information processing apparatus may be also realized as an operational item execution control program for a mobile information processing apparatus.

Also in this case, determination by the pattern-time axis consistency/inconsistency determining process on whether a plurality of pattern orders are consistent on the time axis may be given as a process that determines a plurality of pattern orders as being inconsistent when any of the different patterns registered in the pattern registering process takes place in the course in which patterns occur following the correct order, or may be given as a process that determines a plurality of pattern orders as being consistent even if any of the different patterns registered in the pattern registering means take place in the course on the time axis, by neglecting intervention of these different patterns.

The present invention has been described by referring to the exemplary embodiment, but the present invention should not be limited to the above exemplary embodiment. Various changes that can be understood to those skilled in the art can be made in the configuration and detail of the present invention, within the scope of the present invention.

This application claims priority based on Japanese Patent Application 2007-57687 filed on Mar. 7, 2007, and should incorporate all the disclosure thereof herein.

1. A mobile information processing apparatus comprising:
an arbitrary number of capacitance sensors detecting capacitance at multiple points in a designated area;
a pattern registering unit which registers a plurality of mapped patterns of capacitance at said multiple points in said designated area, obtained from the detection result of said arbitrary number of capacitance sensors;
a pattern/operational item registering unit in which the result of selection when two or more patterns are selected in a designated order from the multiple mutually different patterns registered in said pattern registering unit is registered in combination with a particular operational item for the apparatus;
a pattern evolution determining unit which determines the temporal evolution of said pattern from said arbitrary number of capacitance sensors;
a pattern-time axis consistency/inconsistency determining unit which determines whether the evolution of said pattern determined by said pattern evolution determining unit is consistent on the time axis with the order of the multiple patterns registered in said pattern/operational item registering unit; and
an operational item executing unit which, when consistency was determined by said pattern-time axis consistency/inconsistency determining unit, executes executing the operational item corresponding to said multiple patterns determined to be consistent, among the operational items registered in said pattern/operational item registering unit.

2. The mobile information processing apparatus according to claim 1, wherein said arbitrary number of capacitance sensors is comprised of plural capacitance sensors allotted in the same flat area.

3. The mobile information processing apparatus according to claim 1, wherein said arbitrary number of capacitance sensors is a single flat sensor that covers a single flat area.

4. The mobile information processing apparatus according to claim 1, wherein said arbitrary number of capacitance sensors is constructed of a scanning type one-dimensional capacitance sensor.

5. The mobile information processing apparatus according to claim 1, wherein combinations of said multiple pattern order are registered in correspondence with respective proper plural operational items, in said pattern/operational item registering unit.

6. The mobile information processing apparatus according to claim 1, wherein said pattern-time axis consistency/inconsistency determining unit determines the patterns to be inconsistent when any one of different patterns registered in said pattern registering unit take place in the course in which multiple patterns from said arbitrary number of capacitance sensors occur following the order of multiple patterns registered in said pattern/operational item registering unit.

7. The mobile information processing apparatus according to claim 1, wherein said pattern-time axis consistency/inconsistency determining unit, when any of different patterns registered in said pattern registering unit take place in the course in which multiple patterns from said arbitrary number of Capacitance sensors occur following the order of multiple patterns registered in said pattern/operational item registering unit, neglects interposition of said different patterns and determines the patterns to be consistent.

8. A computer readable recording medium in which an operational item execution control program for making a computer, which is a mobile information processing apparatus having an arbitrary number of capacitance sensors detecting capacitance at multiple points in a designated area, arranged in a designated portion on a casing surface, execute:
a pattern registering process of registering a plurality of mapped patterns of capacitance at said multiple points in said designated area, obtained from the detection result of said arbitrary number of capacitance sensors;
a pattern/operational item registering process in which the result of selection when two or more patterns are selected in a designated order from the multiple mutually different patterns registered in said pattern registering process, is registered in combination with a particular operational item for the apparatus, into a pattern/operational item registering unit;
a pattern evolution determining process of determining the temporal evolution of said pattern from said arbitrary number of capacitance sensors;
a pattern-time axis consistency/inconsistency determining process of determining whether the evolution of said pattern determined by said pattern evolution determining process is consistent on the time axis with the order of the multiple patterns registered by said pattern/operational item registering unit; and
an operational item executing process which, when consistency was determined in said pattern-time axis consistency/inconsistency determining process, executes the operational item corresponding to said multiple patterns determined to be consistent, among the operational items registered in said pattern/operational item registering unit.

9. The computer readable recording medium according to claim 8, wherein in said pattern-time axis consistency/inconsistency determining process, when any one of different patterns registered in said pattern registering unit takes place in the course in which multiple patterns from said arbitrary number of capacitance sensors occur following the order of multiple patterns registered in said pattern/operational item registering unit, it is determined to be inconsistent.

10. The computer readable recording medium according to claim 8, wherein in said pattern-time axis consistency/inconsistency determining process, when any one of different patterns registered in said pattern registering unit takes place in the course in which multiple patterns from said arbitrary number of capacitance sensors occur following the order of multiple patterns registered in said pattern/operational item registering unit, the pattern is determined to be consistent by neglecting interposition of said different patterns.

11. An operational item execution control method effected by a mobile information processing apparatus having an arbitrary number of capacitance sensors detecting capacitance at multiple points in a designated area, arranged in a designated portion on a casing surface, comprising:
registering a plurality of mapped patterns of capacitance at said multiple points in said designated area, obtained from the detection result of said arbitrary number of capacitance sensors;
registering the result of selection when two or more patterns are selected in a designated order from said registered multiple mutually different patterns, in combination with a particular operational item for the apparatus, into a pattern/operational item registering unit;
determining the temporal evolution of said pattern from said arbitrary number of capacitance sensors;
determining whether the evolution of said pattern is consistent on the time axis with the order of the multiple patterns registered in said pattern/operational item registering unit; and
when said consistency was determined, executing the operational item corresponding to said multiple patterns determined to be consistent, among the operational items registered in said pattern/operational item registering unit.

12. A mobile information processing apparatus comprising:
an arbitrary number of capacitance sensors detecting capacitance at multiple points in a designated area;
pattern registering means for registering a plurality of mapped patterns of capacitance at said multiple points in said designated area, obtained from the detection result of said arbitrary number of capacitance sensors;
pattern/operational item registering means in which the result of selection when two or more patterns are selected in a designated order from the multiple mutually different patterns registered in said pattern registering means is registered in combination with a particular operational item for the apparatus;
pattern evolution determining means for determining the temporal evolution of said pattern from said arbitrary number of capacitance sensors;
pattern-time axis consistency/inconsistency determining means for determining whether the evolution of said pattern determined by said pattern evolution determining means is consistent on the time axis with the order of the multiple patterns registered in said pattern/operational item registering means; and
operational item executing means for, when consistency was determined by said pattern-time axis consistency/inconsistency determining means, executing the operational item corresponding to said multiple patterns determined to be consistent, among the operational items registered in said pattern/operational item registering means.
